(19) United States
(12) Patent Application Publication
(10) Pub. No.: US 2018/0266181 A1
(43) Pub. Date: Sep. 20, 2018

(54) STIFFNESS TUNING AND DYNAMIC FORCE BALANCING ROTORS OF DOWNHOLE DRILLING MOTORS

(71) Applicant: Halliburton Energy Services, Inc., Houston, TX (US)

(72) Inventors: Victor GAWSKI, Whitecairns (GB); John K. SNYDER, Bakersfield, CA (US); Michael John STRACHAN, Conroe, TX (US)

(73) Assignee: Halliburton Energy Services, Inc., Houston, TX (US)

(21) Appl. No.: 15/760,999

(22) PCT Filed: Mar. 17, 2016
(86) PCT No.: PCT/US2016/022936

§ 371 Date: Mar. 16, 2018

(30) Foreign Application Priority Data
Nov. 30, 2015 (US) PCT/US2015/062988

(51) Int. Cl. E21B 4/02; E21B 7/06; F04C 14/20; F04C 2/107

(52) U.S. Cl. CPC E21B 4/02; E21B 7/067; F03B 13/02; F04C 2/1071; F04C 14/20

(57) ABSTRACT

A method of manufacturing a power unit for a downhole drilling motor includes fabricating a stator that provides two or more stator lobes that define an internal profile, and fabricating a rotor that provides at least one rotor lobe that defines an external profile that both rotates and precesses within the internal profile during operation. At least one of an external geometry and an internal geometry of the rotor along all or a portion of the rotor may be varied to alter a stiffness and mass of the rotor and thereby optimize stiffness and force balancing with respect to the stator. The rotor may then be rotatably positioned within the stator and thereby optimize the functioning and reliability of the motor power unit, of the downhole drilling motor assembly, of associated downhole drilling equipment, and to enhance directional drilling tendency modelling and directional drilling trajectory control.

### CROSS-REFERENCE TO RELATED APPLICATIONS

The present application is a continuation of International Application. No. PCT/US2015/62988, filed Nov. 30, 2015, and claims priority thereto.

### BACKGROUND

Positive displacement downhole drilling motors (also referred to as “PDM's” and “mud motors”) used in the oil and gas industry are tubular assemblies consisting generally of a progressing cavity power unit, a transmission unit, and an output driveshaft. Downhole drilling motors are typically connected directly to a drill bit at the output end of the motor driveshaft and operate on the reverse application of the Moineau progressing cavity pump principle. In this type of motor design, a stator and rotor combination of the power unit converts hydraulic energy of a pressurized circulating fluid to mechanical energy of the rotating output driveshaft.

The rotor and stator are typically of lobed design, with the rotor and stator having similarly lobed profiles. In general, the power unit may be categorized based upon the number of lobes and effective stages. The rotor is generally formed from steel or stainless steel and has one less lobe than the stator, which is often lined with an elastomer layer. The rotor and stator lobes exhibit a helical configuration with one stage equating to the linear distance of a full 360° wrap of the stator helix. The complementary lobes of the rotor and the stator and the associated helix angles are designed such that the rotor and the stator seal at discrete intervals, which results in the creation of axial fluid chambers or cavities that are filled by the pressurized circulating fluid. The action of the pressurized circulating fluid causes the rotor to rotate and precess within the stator. Motor output torque is directly proportional to the differential pressure developed across the rotor and the stator during operation. In drilling operations, the rotation speed of an associated drill bit is directly proportional to the circulating fluid flow rate between the rotor and the stator.

Downhole drilling motors typically form part of a bottom hole assembly (BHA) included in a string of drill pipe (i.e., a drill string) extended downhole from a surface location, such as a drilling rig or platform. The external physical loading of the downhole drilling motor is directly influenced by the torsional and compressive or tensile loads applied from the surface via the drill string, upon the relative geometries of the wellbore and the drilling assembly components, and upon the physical characteristics of the motor itself, including the use of stabilizers (if any) and associated drilling equipment included in the BHA. Additionally, the downhole environment (e.g. geothermal temperature), drilling fluid characteristics and interaction between the drill bit and the underlying formation can influence the downhole drilling motor.

External motor loading can result in bending of the rotor and the stator and, since the stator typically exhibits a lower stiffness than the rotor, the stator will tend to bend first and the stiffer rotor will impart irregular mechanical loading into the elastomer lining of the stator. More particularly, as the rotor rotates within the stator during use, centrifugal loading is created due to the mass of the rotor, and such centrifugal loading is resisted by the elastomer lining along all or a portion of the length of the rotor. Rotation of a transmission unit coupled to the rotor also generates centrifugal loading that is transferred to the rotor and is also resisted by the elastomer lining. Consequently, the elastomer lining performs a radial bearing function for the rotating mass of the rotor and a portion of the mass of the transmission unit.

Such bending and centrifugally induced loading can reduce fluid sealing efficiency and power production, accelerate stator elastomer degradation, increase rotor and stator lobe profile wear, can potentially cause significant damage to associated components within the downhole drilling motor, and can negatively affect directional drilling control. Directional drilling trajectory objectives are planned for by accurately mechanically modelling the BHA, to an individual drilling tool sub-component level, and as an overall system, relative to the downhole conditions and surface applied operating parameters.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 depicts an exemplary well system that may employ the principles of the present disclosure.

FIG. 2 is a side elevation view partially in cutaway of an exemplary downhole drilling motor.

FIG. 2A is a view of an exemplary embodiment of a downhole drilling motor that schematically depicts the geometric and mechanical interaction of the motor within a wellbore.

FIGS. 3A-3D are cross-sectional end views of various exemplary embodiments of the power unit of FIG. 2.

FIGS. 4A-4C depict cross-sectional side views of exemplary embodiments of the rotor of FIGS. 2 and 3A-3D in accordance with the principles of the present disclosure.

FIG. 5 is a cross-sectional end view of an exemplary embodiment of the power unit of FIG. 2 that schematically depicts the geometric interaction between the rotor and the stator.

### DETAILED DESCRIPTION

The present disclosure is related to downhole drilling motors and, more particularly, to tuning and balancing the stiffness and dynamic forces of the rotor included in a downhole drilling motor.

Embodiments described herein provides methods to optimize and otherwise mitigate the effects of dynamic internal and external mechanical loading of a rotor-stator combination of a downhole drilling motor. This may be accomplished by optimizing the stiffness of the rotor to thereby compliment the stiffness exhibited by the stator, which may benefit performance and component reliability of the downhole drilling motor and enhance directional drilling control. This may also be accomplished by optimizing and balancing the centrifugal loading caused by the rotating mass of the rotor, which may also benefit performance and component reliability of the downhole drilling motor, but also benefit the performance and reliability of associated downhole drilling equipment positioned above or below the motor. Such associated downhole drilling equipment can include, but is not limited to, a Measurement While Drilling “MWD” tool, a Rotary Steerable System “RSS,” and Weight On Bit “WOB,” Torque On Bit “TOB,” and Bending On Bit “BOB” measurement tools.

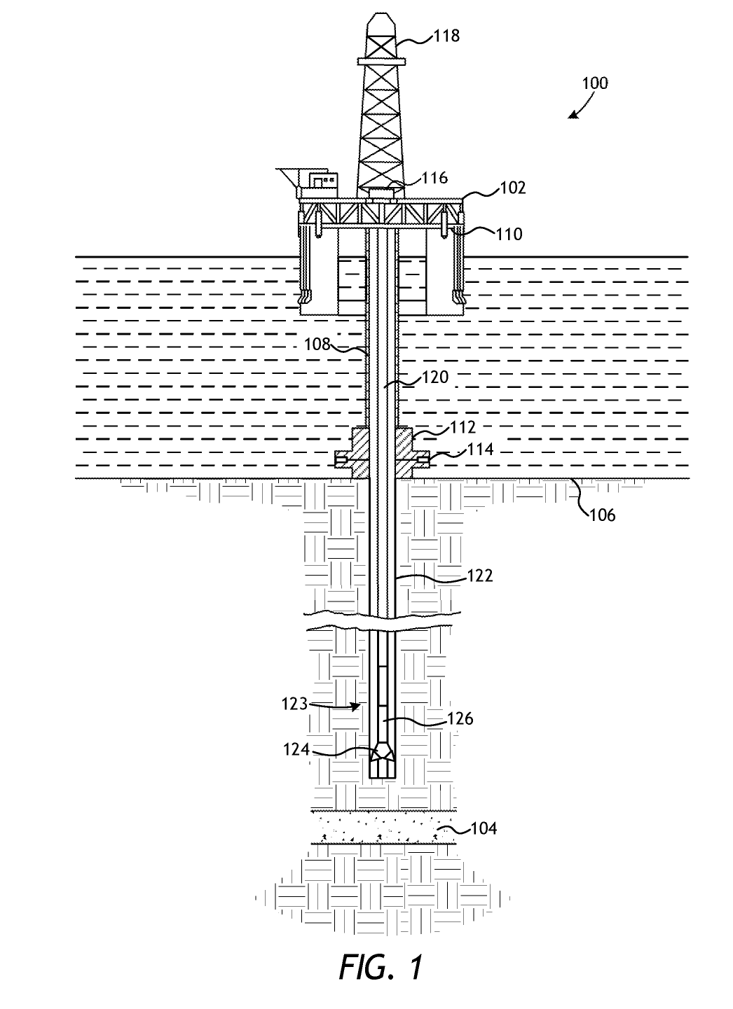

FIG. 1 depicts an exemplary well system 100 that may employ the principles of the present disclosure. More particularly, the well system 100 may include an offshore, semi-submersible oil and gas production platform 102 centered over a submerged oil and gas formation 104 located below a sea floor 106. A subsea conduit or riser 108 extends from a deck 110 of the platform 102 to a wellhead installation 112 that may include one or more blowout preventers 114. The platform 102 has a hoisting apparatus 116 and a derrick 118 for raising and lowering tubular lengths of drill pipe, such as a drill string 120.

A wellbore 122 extends through the various earth strata toward the subterranean hydrocarbon bearing formation 104 and the drill string 120 is extended within the wellbore 122. At its distal end, the drill string 120 includes a bottom hole assembly (BHA) 123 that includes a drill bit 124 and a downhole drilling motor 126, also referred to as a positive displacement motor (“PDM”) or “mud motor”.

As explained in more detail below, circulating fluid is pumped through an interior fluid passageway of the drill string 120 to the downhole drilling motor 126, which converts the hydraulic energy of the circulating fluid to mechanical energy in the form of a rotating rotor. The rotor is coupled to the drill bit 124 via a transmission unit and output driveshaft to cause rotation of the drill bit 124, and thereby allows the wellbore 122 to be extended.

Even though FIG. 1 depicts a vertical wellbore 122 being drilled, it should be understood by those skilled in the art that the downhole drilling motor 126 is equally well suited for use in horizontal or deviated wellbores. It will also be understood by those skilled in the art that the use of directional terms such as above, below, upper, lower, upward, downward and the like are used in relation to the illustrative embodiments as they are depicted in the figures, the upward direction being toward the top of the corresponding figure and the downward direction being toward the bottom of the corresponding figure. In addition, even though FIG. 1 depicts an offshore operation, it should be understood by those skilled in the art that the downhole drilling motor 126 is equally well suited for use in onshore operations.

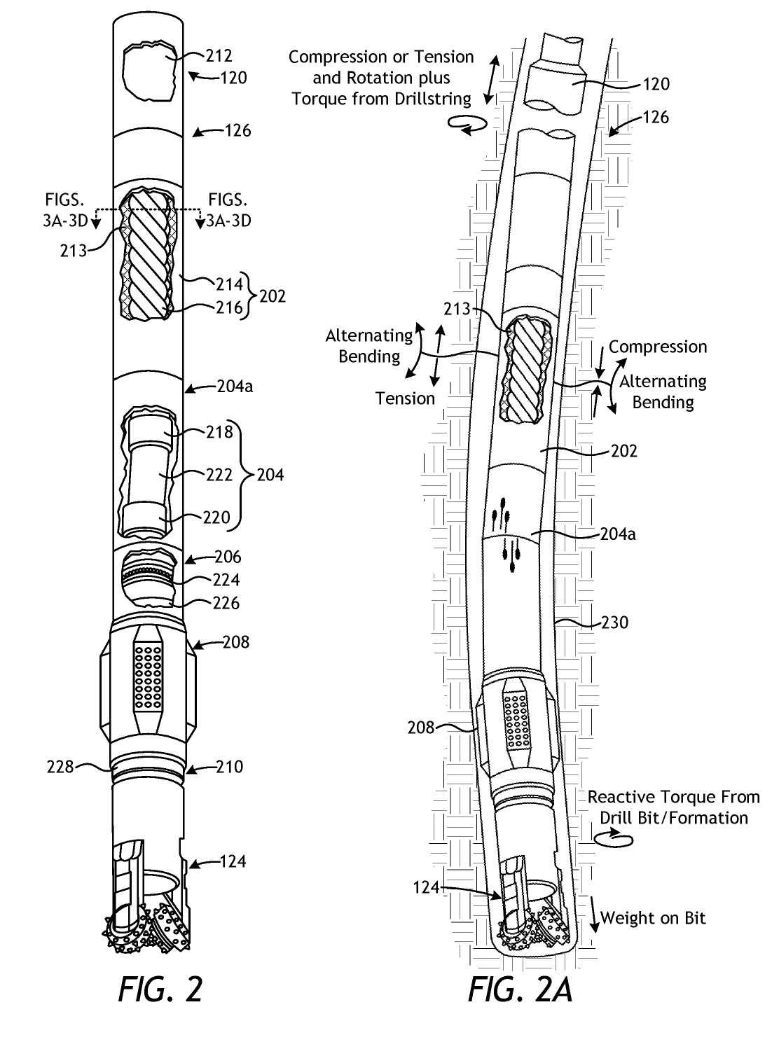

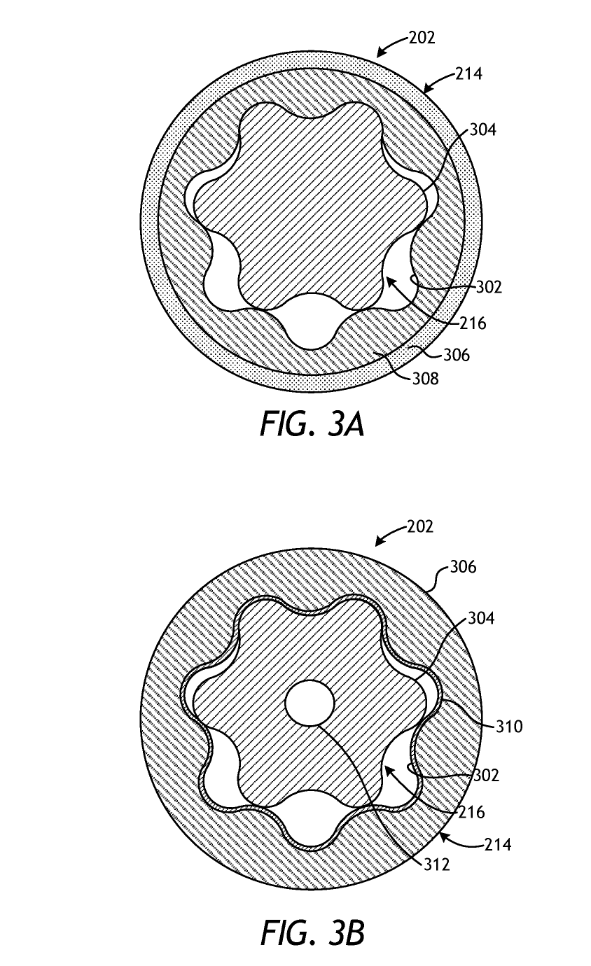

FIG. 2 depicts an exemplary embodiment of the downhole drilling motor 126 of FIG. 1, according to one or more embodiments. As illustrated, the downhole drilling motor 126 (hereafter “the motor 126”) may be coupled to a lower end of the drill string 120 and may include a power unit 202, a transmission section 204 housed within an angularly ‘offset housing’ 204a, a bearing section 206, a stabilizer section 208 and a drill bit section 210 that includes the drill bit 124. The drill string 120 includes an interior fluid passageway 212 for transporting a circulating fluid to an internal fluid passageway 213 defined in the power unit 202 to drive the motor 126. In some cases, the circulating fluid may comprise drilling fluid (also known as “mud”), which may be used to cool the drill bit 124 and carry cuttings back to the surface. In other cases, the motor 126 may be configured to accommodate other types of circulating fluids, including water, air, and foam while producing the output characteristics required to achieve effective drilling of underlying subterranean formations (i.e., the formation 104 of FIG. 1).

The power unit 202 includes an internally profiled stator 214 and an externally profiled rotor 216, various configurations of which will be discussed in detail below. The transmission section 204 may include one or a pair of articulated connections 218, 220 and a transmission shaft 222, which work together to eliminate the eccentric motion of the rotor 216 while transmitting torque and downthrust. The hydraulic energy of the pressurized circulating fluid flowing through the power unit 202 is converted to mechanical energy via the rotating and precessing rotor 216. The action of the circulating fluid across the cross-section of the rotor 216, which is effectively sealed within the stator 214, also produces a hydraulic downthrust on the rotor 216.

The transmission shaft 222 can be a multi-element assembly or a one-piece flexible shaft (e.g., a torsion rod), and may be connected to the lower end of the rotor 216 at the upper connection 218 and connected to an output driveshaft 226 at the lower connection 220. The upper end of the transmission shaft 222 may be under the influence of the eccentric movement of the rotor 216 within the stator 214, while the lower end of the transmission shaft 222 rotates concentrically with the driveshaft 226 and thereby transmits torque and downthrust to the driveshaft 226. The transmission shaft 222 operates to eliminate the eccentric motion of the rotor 216 and the geometric effects of a fixed or rig-site adjustable angularly offset housing 204a (i.e., a “bent housing”) within the motor 126. Accordingly, the transmission shaft 222 allows for the optimum longitudinal axis relationship of the rotor 216 to the stator 214, and thereby ensuring efficient rotor-to-stator sealing and efficiency while minimizing wear on the rotor 216 and the stator 214.

While a particular transmission section has been illustrated in FIG. 2, those skilled in the art will readily appreciate that other types of transmissions could be used in conjunction with the present disclosure, including transmissions having multi-element designs that utilize universal couplings, for example.

The bearing section 206 may include a variety of bearings 224, such as thrust bearings and radial bearings. The thrust bearings may operate to support the downthrust from the transmission section 204 and the reactive upward loading from the applied weight on the drill bit 124, and the radial bearings may operate to absorb lateral side loading of the driveshaft 226 that extends from the transmission section 204. The driveshaft 226 is operatively coupled to and otherwise transmits both axial and torsional loading to the drill bit 124.

The external stabilizer section 208 includes a plurality of blades or pads that provide both stabilization and protection to the motor 126. The driveshaft 226 includes a drill bit connector 228 that threadably receives the drill bit 124 to couple the driveshaft 226 with the drill bit 124.

FIG. 2A depicts another exemplary embodiment of the downhole drilling motor 126 of FIG. 1, according to one or more additional embodiments. More particularly, FIG. 2A schematically illustrates the various mechanical loading forces that may be applied to the motor 126 while drilling a directional wellbore 230. As illustrated, the drill string 120 conveys compression or tension to the motor 126, and as it rotates, the drill string 120 further conveys torque to the motor 126. During operation, the power unit 120 is acted upon by compression, tension, and alternating bending forces. A reactive torque is generated as the drill bit 124 engages the underlying formation, resulting from weight being applied to the drill bit 124 and the motor 126 from a surface location via the drill string 120.

Downhole motor drilling is undertaken with the drill string 120 stationary and while rotating. When there is no rotation of the drill string 120 this is referred to as “slide mode” drilling. While drilling in slide mode, the motor 126 is always pumped through or operational before the drill bit 124 engages the bottom of the borehole. When weight-on-bit (WOB) is applied by the drill string 120 during on-bottom drilling or forward-reaming, the compressive load from the drill string 120 interacts with the inherent stiffness of the motor 126. The motor housings and driveshaft 226 (FIG. 2) tend to be compressed by the applied WOB. In some applications the compressive load can be sufficient to bend the stator housing (the stator 214 is positioned near the motor bend point), this produces additional loading between the mated rotor and stator lobe forms and any rotor coating or stator lining. The wall of the wellbore 230 also produces a physical restriction to movement of the motor 126. Tensile load is imparted to the side of the housings about the inside of the bend in the motor 126, thereby tending to reduce compression in the housings about the inside of the bend. When the motor 226 is pumped-through/operated and during rotation of the rotor 216 and the interconnected transmission and driveshaft 226, bending loads in the rotor 216, the transmission section 204, and driveshaft 226 fluctuate. The bending load fluctuations produce additional loading between the mated rotor and stator lobe forms and any coatings or stator lining. The driveshaft 226 bears both the rotor hydraulic downthrust compressive loading and the reaction to the WOB compressive loading (these act in opposite directions), plus torque generated by the motor 126 in reaction to drill bit 124-formation interactions (at the drill bit 124 face and periphery). Driveshaft 226 compressive and torsional loading fluctuates during its rotation and depends on motor 126 geometry and stiffness, wellbore geometry, drill bit 124-formation interactions (at the drill bit 124 face and periphery) and any BHA-wellbore 230 interactions. When circulating in the same position with the drill bit 124 off-bottom, the wall of the wellbore 230 wall can produce a physical restriction. More particularly, the interaction of the wall of the wellbore 230 and the inherent stiffness of the motor 126 results in tensile loading of the side of the housings about the inside of the bend in the motor 126. Tensile loading of the stator housing promotes bending of the stator housing, which produces additional loading between the mated rotor and stator lobe forms and any coatings or stator lining.

When back-reaming, upwards-pull or tensile load is applied to the drill string 120. The wellbore 230 wall produces a physical restriction and imparts tensile load to the side of the housings about the inside of the bend in the motor 126. Any drill bit 124-formation interactions (at the drill bit 124 periphery) and any BHA-wellbore interactions increase the tensile loads imparted to the motor 126 and the BHA. Tensile loading of the stator housing promotes bending of the stator housing, which produces additional loading between the mated rotor and stator lobe forms and any rotor coating or stator lining. When the motor 126 is pumped-through/operated, during a rotation of the rotor 216 and the interconnected transmission and driveshaft 226, the bending loads in the rotor 216, the transmission section, and the driveshaft 226 fluctuate. The bending load fluctuations produce additional loading between the mated rotor and stator lobe forms and any rotor coating or stator lining. The driveshaft 226 bears the rotor hydraulic downthrust compressive loading and opposing tensile load applied via the drill string 120, plus torque generated by the motor 126 in reaction to drill bit 124-formation interactions. Driveshaft 226 net longitudinal loading can be compressive or tensile. Driveshaft 226 longitudinal and torsional loadings fluctuate during its rotation, depending on motor geometry, wellbore geometry, drill bit-formation interactions and any BHA-wellbore interactions.

When drilling in rotary mode, the motor 126 is always pumped through or operational before the drill string 120 is rotated and before the drill bit 124 engages the bottom of the borehole. When the drill string 120 rotates, drill string 120 torque and WOB are applied to the motor 126 during drilling or forward reaming, WOB compressive load interacts with the inherent stiffness of the motor 126. The motor 126 tends to be compressed by the applied WOB, the compression in the side of the motor housings about the inside of the bend tends to reduce as the hole wall produces a physical restriction. A resulting tensile load is imparted into the housings about the inside of the bend in the motor 126. In some applications, the compressive load can be sufficient to bend the stator housing, which produces additional loading between the mated rotor and stator lobe forms and any rotor coating or stator lining. The hole wall provides a physical restriction to motor 126 movement; tensile load is imparted to the side of the housings about the inside of the motor 126 bend, tending to reduce any compression in the housings about the inside of the bend. Torque delivered from the drill string 126 is borne by the stator 214, the rotor 216 and interconnected transmission and driveshaft 226. Motor 126 housing loading fluctuates during motor 126 rotation, depending on motor 126 geometry, wellbore 230 geometry, drill bit-formation interactions (at bit face and periphery) and any BHA-wellbore interactions. When the motor 126 is also pumped-through/operated, during a rotation of the rotor 216 and interconnected transmission and driveshaft 226, the bending loads in the rotor 216, transmission and driveshaft 226 fluctuate. The bending load fluctuations produce additional loading between the mated rotor and stator lobe forms and any coatings or stator lining. The driveshaft 226 bears both the rotor 216 hydraulic downthrust compressive loading and the reaction to the WOB compressive loading (these act in opposite directions), plus torque delivered from the drill string 120 and torque generated by the motor 126 in reaction to drill bit 124-formation interactions. The driveshaft 226 compressive and torsional loading fluctuates during its rotation, depending on the motor 126 geometry and stiffness, wellbore 230 geometry, drill bit 124-formation interactions (at the drill bit 124 face and periphery) and any BHA-wellbore interactions.

When rotating the drill string 120 and circulating in the same position with the drill bit 124 off-bottom, the inherent stiffness of the motor 126 and the drill string 120 torque interact. The hole wall produces a physical restriction, a resulting tensile load is imparted into the side of the housings about the inside of the bend in the motor 126. The side of the housings on the inside of the bend tend to be in tension. Tensile loading of the stator housing promotes bending of the stator housing, this produces additional loading between the mated rotor and stator lobe forms and any coatings or stator lining. Torque delivered from the drill string 120 is borne by the stator 214, the rotor 216, and interconnected transmission and driveshaft 226. The motor 126 housing loading fluctuates during motor 126 rotation depending on the motor 126 geometry, the wellbore 230 geometry, and any BHA-wellbore interactions. When the motor 126 is also pumped-through/operated, during rotation of the rotor 216 and interconnected transmission and driveshaft 226, the bending loads in the rotor 216, transmission, and driveshaft 226 fluctuate. The bending load fluctuations produce additional loading between the mated rotor and stator lobe forms and any rotor coating or stator lining. There are additional loadings caused by the torque delivered from the drill string 120. The driveshaft 226 bears the rotor 216 hydraulic downthrust compressive loading, plus torque delivered from the drill string 120 and generated by the motor 126 in reaction to the drill bit 124-formation interactions. The driveshaft 226 compressive and torsional loading fluctuates during its rotation, depending on the motor 126 geometry and stiffness, the wellbore 230 geometry, the drill bit 124-formation interactions, and any BHA-wellbore interactions.

When back-reaming with drill string 120 rotation, the drill string 120 torsion and tensile load are applied to the motor 126, and the applied tensile load interacts with the inherent stiffness of the motor 126. The motor 126 housings tend to be loaded in tension by the applied upwards pull, plus the hole wall produces a restriction and resulting tensile load into the side of the housings about the inside of the bend in the motor 126. Tensile loading of the stator housing promotes bending of the stator housing, this produces additional loading between the mated rotor and stator lobe forms and any coatings or stator lining. Torque delivered from the drill string 120 is borne by the stator housing and lobe form, the rotor 216 and its lobe form, the interconnected transmission, and the driveshaft 226. The motor 126 housing loading fluctuates during motor 126 rotation, depending on the motor 126 geometry, the wellbore 230 geometry, the drill bit 124-formation interactions and any BHA-wellbore interactions. When the motor 126 is also pumped-through/operated, during rotation of the rotor 216 and interconnected transmission and driveshaft 226, the bending loads in the rotor 216, transmission and driveshaft 226 fluctuate. The bending load fluctuations produce additional loading between the mated rotor and stator lobe forms and any coatings or stator lining. There are additional loadings caused by the torque delivered from the drill string 120. The driveshaft 226 bears the rotor 216 hydraulic downthrust compressive loading, any tensile loading caused by any wellbore 230 interactions at the periphery of the drill bit 124, plus torque delivered from the drill string 120 and generated by the motor 126, in reaction to drill bit 124-formation interactions. The driveshaft 226 net longitudinal loading can be compressive or tensile. The driveshaft 226 longitudinal and torsional loadings fluctuate during its rotation, depending on the motor 126 geometry, the wellbore 230 geometry, the drill bit 124-formation interactions and any BHA-wellbore interactions.

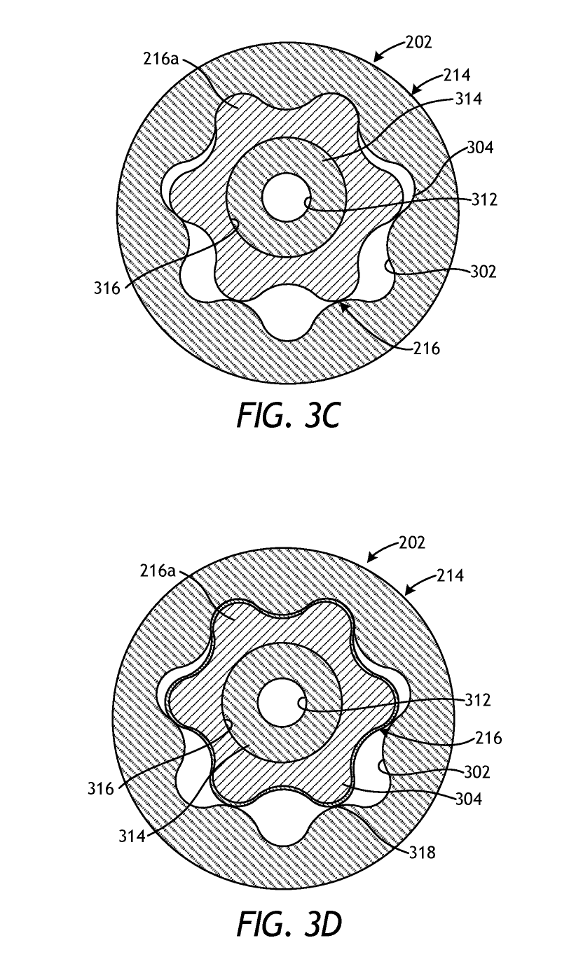

FIGS. 3A-3D are cross-sectional end views of various exemplary embodiments of the power unit 202 as taken along the indicated lines in FIG. 2, according to embodiments of the present disclosure. As illustrated, the power unit 202 in each embodiment includes the stator 214 and the rotor 216. The stator 214 provides a multi-staged, profiled inner surface that defines a plurality of stator lobes 302 that have a helical configuration wherein each stage is defined by the linear distance of one full 360° wrap of the stator helix. In the illustrated embodiments, the stator 214 has seven lobes 302, but it will be appreciated that the power unit 202 may incorporate the use of more or less than seven lobes 302, without departing from the scope of the present disclosure.

The number of stator lobes 302 used in the power unit 202 may be determined based upon factors including the desired speed of rotation and the desired torque. Power units of the same diameter but having fewer stator lobes generally operate at higher speeds and deliver lower torque per unit length as compared to power units having a greater number stator lobes that tend to operate at lower speeds but deliver greater torque. In some embodiments, the power unit 202 may include between two and ten stator lobes 302, but the power unit 202 may alternatively include more than ten stator lobes 302, without departing from the scope of the present disclosure.

The rotor 216 in FIGS. 3A-3D has a profiled outer surface that closely matches the profiled inner surface of the stator 214 to provide a close fitting relationship, such as an interference (compression) or a clearance cross-sectional fit. The profiled outer surface of the rotor 216 defines a plurality of rotor lobes 304 that, similar to the stator lobes 302, exhibit a helical configuration. In the illustrated embodiments, the rotor 216 has six lobes 304, but it will be appreciated that the power unit 202 may incorporate the use of more or less than six lobes 304, without departing from the scope of the present disclosure. The number of rotor lobes 304 used in the power unit 202 will be determined based upon the number of stator lobes 302, with the number of rotor lobes 304 being one less than the number of stator lobes 304. For example, if the number of stator lobes 302 is (n), then the number of rotor lobes 304 will be (n−1).

The profiles of the lobes 302, 304 may be similar, but the effective operating diameter of the lobes 302, 304 is different. As described in more detail below, for instance, the stator lobes 302 are set on a larger operating diameter than that of the rotor lobes 304. Modification of the numbers of lobes 302, 304 provides for variation of the input and output operating characteristics of the power unit 202 to accommodate different drilling operations requirements. The rotor 216 is inserted into the stator 214 during assembly of the drilling motor power unit 202. The effective operating stages of the power unit 202 depend on the longitudinal length along which the rotor and stator lobed profiles directly interact, mate, or mesh.

In FIG. 3A, the stator 214 includes a stator housing 306 and a stator sleeve 308 disposed within the stator housing 306. The stator housing 306 may be formed from a metal, such as a ferrous metal including steels and stainless steels. Alternatively, the stator housing 306 may be formed of other rigid, non-metallic materials including, but not limited to, carbon fiber, a polymer composite, or other rigid composite materials. The stator housing 306 has an inner surface sized to the receive stator sleeve 308, and the stator sleeve 308 may be coupled to the stator housing 306 using a system of tapers, orientation keys, matched surfaces, threaded components or the like that are designed to torsionally and longitudinally support the stator sleeve 308 within the stator housing 306 during operation. The stator sleeve 308 may be formed from a malleable metal, such as steel alloys, aluminum, aluminum alloys, copper, copper alloys (e.g., beryllium copper alloys), bronze, bronze alloys (e.g., magnesium bronze, aluminum bronze, etc.), or similar metals.

In some embodiments, as illustrated, the rotor 216 may comprise a solid, elongate structure milled and otherwise formed from a metal such as a ferrous metal including steels and stainless steels. In such embodiments, the helical lobes 304 of the rotor 216 may be precision formed using multi-axis milling to tight axial and radial tolerances. Alternatively, the rotor 216 may be manufactured via swaging (cold working) or a pressure forming technique. In some embodiments, the outer surface of the rotor 216 may be treated with a treatment process such as, but not limited to, salt bath nitriding, gas nitriding, plasma nitriding, ion nitriding, ion plating, inductive hardening, anodizing, thermal metallic spraying, or the like. Such treatment processes modify surface properties of the rotor 216, such as maximizing wear and corrosion resistance, but not the surface geometry. In operating the power unit 202, the rotor 216 rotates and precesses within the stator 214 and, in at least one embodiment, there may be metal-to-metal contact between the outer surface of the rotor 216 and the inner surface of the stator 214, which are formed from dissimilar metals.

Alternatively, the stator sleeve 308 may be formed from a polymer. For example, the stator sleeve 308 may be made of polychloroprene rubber (CR), natural rubber (NR), polyether eurethane (EU), styrene butadiene rubber (SBR), ethylene propylene (EPR), ethylene propylene diene (EPDM), a nitrile rubber, a copolymer of acrylonitrile and butadiene (NBR), carboxylated acrylonitrile butadiene (XNBR), hydrogenated acrylonitrile butadiene (HNBR), commonly referred to as highly-saturated nitrile (HSN), carboxylated hydrogenated acrylonitrile butadiene (XHNBR), hydrogenated carboxylated acrylonitrile butadiene (HXNBR) or similar material.

When made of an elastomer or rubber, the stator sleeve 308 may be injection molded with detailed attention being given to elastomer composition, uniformity, bond integrity and lobe 302 profile accuracy. In some embodiments, the stator sleeve 308 may be injection molded into or directly sprayed onto the stator housing 306, and the bore of the stator housing 306 may have a bonding agent applied thereto prior to the injection molding or spraying process. In such embodiments, as the rotor 216 rotates within the stator 214 during use, centrifugal load is created due to the mass of the rotor 216, and this is resisted by the elastomeric stator sleeve 308 along the length of the rotor 216. The stator sleeve 308 thus performs a radial bearing function with respect to the rotating mass of the rotor 216.

In FIG. 3B, a stator coating 310 may be applied to the stator housing 306 and the rotor 216 may comprise a tubular structure that defines and otherwise provides a rotor bore 312. The rotor bore 312 may provide a bypass passageway through the rotor 216 for circulating fluids and may help prevent rotor stall under certain conditions.

As illustrated, the stator housing 306 provides a profiled inner surface that defines the stator lobes 302 that receive the stator coating 310 thereon. In some embodiments, the stator coating 310 may comprise a polymer, such as any of the rubbers or elastomers mentioned herein. The internally profiled bore of the stator 214 lined with a uniform thickness elastomer stator coating 310 may reduce elastomer flex and cyclic load levels. The stator coating 310 may also increase operating pressure and output power capacity and reduce heat generation within the stator 214.

In other embodiments, the stator coating 310 may comprise a metal coating, which may be applied using a vapor deposition process, a metallizing process, an arc spraying process, a thermospray process, a flame spray process, a plasma spray process, a high velocity oxy-fuel process, or the like. In such embodiments, the stator coating 310 may be formed from a pure metal, a metal oxide, a metal alloy (e.g., stainless steel, carbon steel, etc.), nickel, a nickel alloy (e.g., nickel-chrome, nickel-chrome-boron, cobalt-nickel-chrome), aluminum, an aluminum alloy or aluminum oxide, bronze, a bronze alloy (e.g., magnesium bronzes and aluminum bronzes), copper, a copper alloy (e.g., beryllium copper alloy), molybdenum, tin, zinc, a zinc alloy, MONEL®, HASTELLOY®, tungsten carbide, tungsten carbide-nickel, tungsten carbide-cobalt, chromium carbide, chromium oxide, titanium or titanium oxide, mirconium oxide, cobalt-molybdenum-chromium, or similar materials. Moreover, the surface of the stator coating 310 may receive a treatment process, such as any of the treatment processes mentioned herein.

In FIG. 3C, the stator 214 is a solid metal stator and the rotor 216 includes a tubular rotor mandrel 314 that defines and otherwise provides the rotor bore 312. More particularly, the rotor 216 may be characterized as a rotor sleeve 216a that comprises a tubular structure defining a central bore 316 sized to receive the rotor mandrel 314. The rotor mandrel 314 may be formed from a metal, such as a ferrous metal including steels and stainless steels, and may be coupled to the rotor 216 at the central bore 316 via a variety of means. For instance, the rotor mandrel 314 may be coupled to the rotor sleeve 216a using a system of complimentary tapers, matched surfaces, orientation keys, and/or threaded components designed to torsionally and longitudinally support the rotor mandrel 314 within the central bore 316. Surfaces of one or both of the stator 214 and the rotor 216 may receive a treatment process, as discussed herein.

The rotor mandrel 314 may prove advantageous in allowing an operator to selectively vary or otherwise tune the stiffness of the combined rotor mandrel 214 and rotor sleeve 216a to compliment the stiffness of the stator 214. As will be appreciated, this may prevent accelerated wear and deterioration when the stator 214 flexes due to mechanical loading during operation and differences in relative stiffness between the rotor 216 and the stator 214. Moreover, the rotor mandrel 314 may help facilitate simplified maintenance of the power unit 202 as the rotor sleeve may be removed from the rotor mandrel 314 for replacement, repair, or refurbishment.

In FIG. 3D, the stator 214 is again a solid metal stator and the rotor 216 again includes the rotor mandrel 314 secured within the central bore 316 and defining the rotor bore 312. The rotor 216 may further include a rotor coating 318 defined on or otherwise formed about the profiled outer surface. In some embodiments, the rotor coating 318 may comprise a polymer, such as any of the rubbers or elastomers listed herein. In other embodiments, however, the rotor coating 318 may comprise a metal coating applied to the profiled outer surface of the rotor 216 via a vapor deposition process, a metallizing process, an arc spraying process, a thermospray process, a flame spray process, a plasma spray process, a high velocity oxy-fuel process or the like. In such embodiments, the rotor coating 318 may comprise any of the metals or metal alloys listed herein for the stator coating 310. Moreover, in at least one embodiment, surfaces of one or both of the rotor coating 318 and the stator 214 may receive a treatment process, such as any of the treatment processes mentioned herein.

While the power unit 202 is shown in FIGS. 3A-3D in specific embodiments having specific component parts, it is noted that any of the rotors 216 described above can operate with any of the stators 214 described above, without departing from the principles of the present disclosure. Accordingly, components of one rotor 216 design or stator 214 design may be used together or removed from another rotor 216 design or stator 214 design, without departing from the principles of the present disclosure. For example, a stator 214 having a stator housing 306 and stator sleeve 308 could also have a stator coating 310, in keeping with the scope of the present disclosure.

Referring again to FIG. 1, with continued reference to FIGS. 2 and 3A-3D, when the drill bit 124 is lowered onto the formation 104 and weight (compression load) is applied to the motor 126 from surface via the drill string 120, an increased operating differential pressure is produced across the power unit 202 and an increased amount of output torque results. The output rotation is dependent on the amount of circulating fluid being pumped through the motor 126. Drilling operations can be undertaken with the drill string 120 stationary or rotating. When rotating, the drill string 120 supplies additional torque and rotation to the motor 126. This combines with the output torque and rotation of the motor 126, the cumulative torque and rotation being supplied to the drill bit 124.

The motor 126 can form part of a bottom hole assembly (BHA) used, among other things, for directional drilling. The BHA enables the inclination and direction of the drilled wellbore 122 to be controlled as desired to meet geologic target objectives. Moreover, the offset or bent housing 204a (FIGS. 2 and 2A) within the motor 126 can be configured during workshop assembly or rig floor adjustment to be geometrically (angularly) offset with respect to the longitudinal axis of the motor 126. As a result, a bend is placed at a specific location within the longitudinal length of the motor 126 and the motor 126 is effectively no longer straight along its full length. The bend, along with the stabilizing elements of the stabilizing section 208 (FIG. 2) and separate components of the BHA 123 positioned above and/or below the motor 126, and thereby affects the tendency that the motor 126 has to drill in a specific direction for a given formation type.

Holding the drill string 120 static or rotating, the physical motor 126 configuration directly influences the direction of the drilled wellbore 122. Varying the WOB (compression load) which is applied to the motor 126 from surface influences the tendency that the motor 126 has to either drill straight ahead or “directionally” to the left, to the right, or to increase or decrease the inclination of the wellbore 122. The surface applied weight on bit loads can be significant and can exceed 100,000 lbf in larger diameter wellbores, and the majority of this load is applied to the downhole drilling motor 126. Drilling in a specific direction or a series of directions facilitates the wellbore 122 reaching specific geologic targets, which can be horizontally displaced from the platform 102, while negating the effects of gravity on the drilling assembly and of any deviation tendencies caused by the physical characteristics of the formation being drilled.

The lobes 302, 304 (FIGS. 3A-3D) of the stator 214 and the rotor 216, respectively, and the associated helix angles may be configured so that the stator 214 and the rotor 216 seal at discrete intervals. This results in the creation of axial fluid chambers or cavities between the stator 214 and the rotor 216, which are progressively filled by the pressurized circulating fluid. As mentioned above, the action of the pressurized circulating fluid causes the rotor 216 to rotate and precess within the stator 214. The geometry of the lobes 302, 304 and the amount of eccentric movement of the rotor 216 is designed to minimize contact pressure, sliding friction, abrasion and vibration, thus reducing wear on the stator 214 and the rotor 216.

The input and output power characteristics of the motor 126 can generally be considered to be a function of the number and geometry of the lobes 302, 304, the helix angle of the lobes 302, 304, and the number of effective stages along the length of the power unit 202. Within the specified motor 126 operating ranges, the rotation speed of the drill bit 124 is directly proportional to the circulating fluid flow rate between the rotor 216 and the stator 214. Above the maximum specified operating differential pressure (pressure per stage) of the power unit 202, fluid leakage occurs between the seals created between the rotor 216 and the stator 214, thereby reducing efficiency, output torque, and output rotation. Excessive fluid leakage results in no rotation of the drill bit 124 due to the rotor 216 becoming stationary, or stalling in the stator 214.

Moreover, within the specified operating ranges of the motor 126, the output torque of the motor 126 is directly proportional to the differential pressure developed across the rotor 216 and the stator 214. If the motor 126 is operated above the maximum specified torque production values, there can be a tendency for accelerated rotor 216 and stator 214 wear, degradation, and stalling. The power developed by the rotor 216 and the stator 214 is directly proportional to both rotational speed and torque.

Designs of the rotor 216 and the stator 214 take account of the various downhole operating parameters that may be present during downhole drilling applications, including the effects of circulating fluid weight/viscosity, temperature, solids content and lost circulation materials content. Chemical constituents of formation fluids and gases are also given detailed consideration with respect to elastomers and other types of coatings applied to either the rotor 216 or the stator 214 (e.g., the stator coating 310 and/or the rotor coating 318 of FIGS. 3B and 3D, respectively).

The metrology system of the rotor 216 and the stator 214 ensures that the rotor 216 and the stator 214 are carefully measured and accurately matched geometrically within small tolerances to provide the optimum mating fit for planned downhole operating conditions. In some embodiments, the mating fits and geometries between the rotor 216 and the stator 214 are selected to accommodate downhole (geothermal) motor drilling operating temperatures, which can exceed 200° C. (392° F.). In some embodiments, the mating fits and geometries between the rotor 216 and the stator 214 are selected to accommodate internally generated motor heat, caused by the rotor 216 interacting with the stator 214. Accordingly, allowance may be made for the effect of motor component expansion caused by the formation temperature and by internally generated heat. As will be appreciated, this avoids motor 126 start-up problems, ensures acceptable output power characteristics, and maximizes reliability and longevity of the rotor 216 and the stator 214.

Mechanical loading of the motor 126 can negatively affect its internal components through wear and through the application of mechanical stress, which can promote internal heat generation, fatigue cracking, and fracture of the components. Such loading also tends to affect the directional drilling tendency and operational control of the motor 126. Significant loads can be applied to the internal components when they are downhole, the loads resulting from operations such as drilling, reaming (back or forward) or circulating fluid when the drill bit 124 is off-bottom. External loading of the motor 126 is dependent on the torsion and compression or tensile loads applied from surface via the drill string 120, upon the relative geometries of the wellbore 122 and the drilling assembly components, and upon the physical characteristics of the motor 126, including the stabilizers of the stabilizer section 208 (FIGS. 2 and 2A) and associated drilling equipment located within the BHA.

The maximum outer diameter for the motor 126 is restricted by the need to provide annular clearance in the wellbore 122 to permit movement of the drilling assembly into and out of the well, and to allow for the flow of circulating fluid and the movement of formation cuttings. The inner dimensions of the motor 126 may be configured to provide adequate housing strength in terms of the compression, tension, torsion and bending loads applied during the drilling process, and must physically accommodate the internal functioning components of the motor 126.

The housing for the stator 214 (e.g., the stator housing 306) may be configured to accommodate the helical lobe form (e.g., the stator sleeve 308 and/or the stator coating 310) of the stator 214 and the rotor 216 that mates, rotates, and precesses within it. When employing a relatively thick stator lining, it may be necessary for the wall thickness of the stator housing to be thinner as compared to a scenario where the circulating fluid was passing through a plain housing bore, as is the case with relatively thick walled drill collars. In some embodiments, the outer surface of the stator housing 306 may be profiled (sometimes referred to as “flexed”) to selectively vary the stiffness of the stator housing 306 and the motor 126.

When sufficient load (compression when drilling or forward-reaming and tension when back-reaming, tripping in-hole or pulling out of hole, etc.) is applied to bend the stator 214 relative to the rotor 216, the stiffness of the rotor 216 may adversely load the lobe form of the rotor 216 and the stator 214, any elastomer lining of the stator 214 or any rotor/stator coatings (e.g., the stator coating 310 and/or the rotor coating 318). During drilling operations with no drill string 120 rotation, one side of the stator housing bore (e.g., the stator sleeve 308 and/or the stator coating 310) may be adversely affected, bending of the rotor 216 and the stator housing 306 can be influenced by the BHA 123 and the motor 126 physically interacting with the sides of the wellbore. In drilling operations where the drill string 120 rotates, however, 360° around the stator housing bore can be adversely loaded. Alternating bending of the rotor 216 and the stator housing 306 can occur due to the BHA 123 and the motor 126 being rotated by the drill string 120 and physically interacting with the sides of the wellbore (FIG. 2A).

Excessive bending loads from the rotor 216 promote fluid leakage between the seal generated between the rotor 216 and the stator 214, thereby reducing output torque and rotation. The loading applied to the stator housing bore, and therefore to the stator lobes 302 (FIGS. 3A-3D), due to the stiffness of the rotor 216, tends to cause elastomer/coating wear and degradation, which promotes elastomer or coating overheating, hardening and cracking.

According to embodiments of the present disclosure, the effects of dynamic internal and external mechanical loading of the rotor-stator combination and of the elastomer lining on the stator 214 (if used) may be optimized and otherwise mitigated for drilling operations. This may be accomplished by optimizing the stiffness of the rotor 216 to thereby compliment the stiffness exhibited by the stator 214, which may benefit performance and component reliability of the motor 126, the reliability of associated drilling equipment within the BHA, and directional drilling control. Similar benefits may also be accomplished by optimizing and balancing the centrifugal loading caused by the rotating mass of the rotor 216 and the coupled transmission assembly comprising the articulated connections 218, 220 and the transmission shaft 222. This may also benefit the performance and reliability of associated drilling equipment within the BHA.

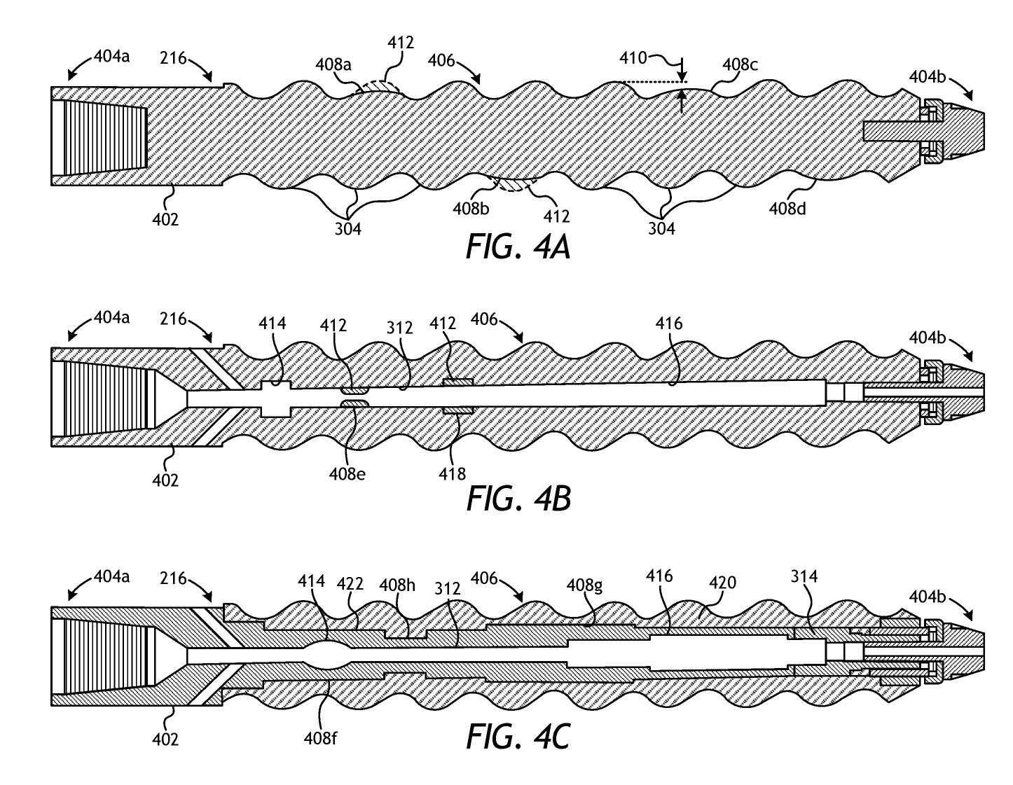

Referring to FIGS. 4A-4C, illustrated are cross-sectional side views of exemplary embodiments of the rotor 216 in accordance with the principles of the present disclosure. As illustrated, the rotor 216 may include an elongate body 402 having a first or lower end 404a and a second or upper end 404b opposite the first end 404b. The first end 404a may comprise a connection configured to receive a corresponding mating component (not shown), such as part of the transmission section 204 (FIG. 2) that allows the rotor 216 to rotate with respect to the stator 214 (FIGS. 2 and 3A-3D). More particularly, the first end 404a may operatively couple the rotor 216 to the transmission shaft 222 (FIG. 2), the driveshaft 226 (FIG. 2), and the drill bit 124 (FIG. 2) such that rotation of the rotor 216 correspondingly rotates the drill bit 124. The second end 404b may comprise a connection configured to receive a corresponding mating component (not shown), such as part of a rotor jet nozzle retainer, a rotor catcher mechanism, or an electricity transmitting rotary slip joint.

As illustrated, the rotor 216 provides and otherwise defines an external profile 406 comprising a plurality of the rotor lobes 304 defined about the circumference of the rotor 216 in a helical pattern. The profile 406 is configured to correspond to an internal helical lobe profile of the stator 214 (FIGS. 3A-3D), as discussed above, and extends at least partially between the first end 404a and the second end 404b. The profile 406 comprises a multi-staged helical configuration, where each stage is defined by the linear distance of one full 360° wrap of the rotor helix about the body 402. While not shown in FIGS. 4A-4C, in some embodiments, the rotor coating 318 of FIG. 3D may be applied to the profile 406, without departing from the scope of the disclosure.

Since the rotor 216 can be manufactured by milling, turning, swaging, cold rolling, pressure forming, or any combination of the foregoing techniques, the rotor 216 may be thin or thick walled and its stiffness can, therefore, vary significantly. This offers an opportunity to selectively vary the stiffness of the rotor 216 relative to the mating stator 214 (FIGS. 2 and 3A-3D) and thereby realize component benefits for the rotor 216 and the stator 214 and also improve directional drilling control. More particularly, and according to embodiments of the present disclosure, the internal and/or external geometry of the rotor 216 may be varied along all or a portion of its length in order to alter the stiffness of the rotor 216 and/or optimize force balancing with respect to the mating stator 214.

In FIG. 4A the rotor 216 is depicted as a solid, elongate structure that may be formed of a metal, for example, such as stainless steel. To vary the stiffness of the rotor 216, the external geometry of the rotor 216 may be modified. More particularly, in some embodiments, the mass of the rotor 216 may be selectively modified by removing material at one or more locations along the axial length of the body 402, as shown at locations 408a, 408b, 408c, and 408d. Removing the material from the one or more locations 408a-d may be accomplished by a variety of machining techniques, such as profiling, undercutting, and recessing. As illustrated, for example, the diameter of the profile 406 of the rotor lobe 304 positioned at the third location 408c may be altered and otherwise profiled, undercut, or recessed over a specific portion 410. In at least one embodiment, the portion 410 may be selectively removed from one of the rotor lobes 304 along all or a portion of its axial length as it helically-winds about the body 402. The portion 410 may be defined either by forming the decreased dimension in the rotor 216 during manufacturing of the rotor 216 (i.e., swaging, milling, turning, etc.) or otherwise the portion 410 may be subsequently machined from the profile 406 to desired tolerances following manufacture. Transition areas at the extents of the profiled, undercut, or recessed zones are profiled in order to minimize stress concentrations. As will be appreciated, by removing mass from selected portions of the rotor 216, the stiffness of the rotor 216 may be selectively decreased at those locations.

In other embodiments, it may be desired to increase the stiffness of the rotor 216. In such embodiments, one or more stiffening elements 412 may be selectively secured to the outer periphery of the body 402, such as is shown at the first and second locations 408a,b. In some cases, the stiffening elements 412 may be secured to the body 402 during manufacture of the rotor 216, and thereby forming an integral part of the rotor 216 and the associated profile 406. In other cases, however, portions of the profile 406 may be removed by milling out or otherwise manufactured to smaller dimensions and the stiffening elements 412 may subsequently be attached to the rotor 216 at the locations where the geometry of the profile 406 was altered.

The stiffening elements 412 may comprise a metallic or non-metallic material or substance, which has specific physical characteristics relative to that of the remaining or surrounding portions of the body 402. Suitable materials that may be used as stiffening elements 412 include, but are not limited to, lead, steel, carbon-fiber, a polymer nano-composite, a liquid sealed in a container, a piezoelectric fluid, a magneto-restrictive fluid, or any combination thereof. In some embodiments, the stiffening elements 412 may comprise weighting elements that may serve to balance the weight of the rotor 216 in rotation and thereby provide dynamic force balancing of the rotor 216.

In FIG. 4B, the rotor 216 is depicted as defining and otherwise providing the rotor bore 312, which, as discussed above, provides a bypass passageway through the rotor 216 for circulating fluids. The stiffness of the rotor 216 in FIG. 4B may be altered by varying the external geometry of the rotor 216 (i.e., the profile 406), as described above with reference to FIG. 4A, but also by varying the internal geometry of the rotor bore 312 along all or a portion thereof. In some embodiments, mass of the rotor 216 may be selectively removed at discrete (short) or extended (long) portions of the rotor bore 312, thereby decreasing the stiffness of the rotor 216 at such discrete or extended portions. For instance, one or more undercuts or internal recesses 414 (one shown) may be defined in the rotor bore 312 at a corresponding one or more discrete locations. The internal recess 414 effectively removes material from the rotor 216 at that location, and thereby decrease the stiffness of the rotor 216.

While the internal recess 414 is depicted in FIG. 4B as being located at a discrete location, it is also contemplated herein to extend the axial length or a large portion of the rotor bore 312. In such embodiments, the internal recess 414 may effectively enlarge the diameter of the rotor bore 312 and simultaneously decrease the stiffness of the rotor 216. Moreover, rather than providing 90° corners, as illustrated, the corners of the internal recess 414 may be rounded or angled (i.e., offset from 90°), which may prove advantageous in enhancing fatigue resistance during bending since abrupt structural changes in structural components are more prone to cracking and/or failure.

In other embodiments, mass of the rotor 216 may be selectively removed by defining and otherwise providing one or more profiles 416 (one shown) in the rotor bore 312 that may vary axially according to a function across all or a portion of the rotor bore 312. In the illustrated embodiment, the profile 416 tapers radially outward from left to right according to a linear function, and thereby correspondingly increases the diameter of the rotor bore 312 in the same direction. In other embodiments, however, the profiles 416 may vary according to a polynomial function that includes multiple diametrical variations or changes along all or a portion of the axial length of the rotor bore 312. In yet other embodiments, the profiles 416 may vary according to a stepped or square function where the diameter of the rotor bore 302 increases and/or decreases in step-wise fashion along all or a portion of the axial length of the rotor bore 312. In such embodiments, rather than providing 90° corners, one or more of the steps of the stepped function may define rounded or angled (offset from 90°) corners, which, as mentioned above, may enhance fatigue resistance.

As will be appreciated, the profile 416 removes mass from the rotor 216 and thereby varies (decreases) its stiffness. In downhole drilling motors, power units often fail near the bottom of the stator 214 (FIGS. 2 and 3A-3D) since the weight of the transmission shaft 222 (FIG. 2) directly affects rotation of the rotor 216. By altering the stiffness of the rotor 216 toward the second end 404b, it may be possible to negate the effects of the mass of the transmission shaft 222 and the connections 218, 220 (FIG. 2).

In some embodiments, it may be desired to increase the stiffness of the rotor 216 at select locations along its axial length. In such embodiments, the profiles 416 may alternatively be utilized to add mass to the rotor 216 by decreasing the diameter of the rotor bore 312 according to a function (i.e., linear, polynomial, square, etc.), without departing from the scope of the disclosure. The stiffness of the rotor 216 may alternatively (or in addition thereto) be increased by selectively positioning one or more stiffening elements 412 within the rotor bore 312 at discrete (short) or extended (long) internal recesses. In some embodiments, for instance, as shown at location 408e, one or more stiffening insert elements 412 in the form of cylindrical sleeves or strips may be secured to the inner wall of the rotor bore 312, and thereby effectively decrease the diameter of the rotor bore 312. In other embodiments, however, one or more stiffening elements 412 may be positioned within a corresponding internal recess 418 defined in the rotor bore 312 such that the stiffening elements 412 do not obstruct the flow passageway of the rotor bore 312.

In FIG. 4C, the rotor 216 includes a rotor mandrel 314, which may be solid along its longitudinal axis or, as illustrated, may include the rotor bore 312. The portion of the rotor 216 surrounding the rotor mandrel 314 may be referred to as a rotor sleeve 420, which defines the profile 406 at its outer geometry. The stiffness of the rotor 216 in FIG. 4C may be altered by varying the external geometry of the rotor 216 (i.e., the profile 406), as described above with reference to FIG. 4A, by varying the internal geometry of the rotor bore 312 along all or a portion thereof, as described above with reference to FIG. 4B, and by adding or removing mass from one or both of the rotor mandrel 314 and the rotor sleeve 420 at an interface 422 therebetween. The material of the rotor mandrel 314 and the rotor sleeve 420 may be the same or dissimilar. In embodiments where the materials are different, an operator may selectively remove mass from one or both of the rotor mandrel 314 and the rotor sleeve 420 to vary and otherwise optimize the stiffness of the rotor 216 along its axial length.

Similar to the embodiment of FIG. 4B, the rotor bore 312 may define one or more internal recesses 414 (one shown), as shown at location 408f. As illustrated, the internal recess 414 may define a specific cross-section profile. Moreover, similar to the embodiment of FIG. 4B, the rotor bore 312 may also define one or more profiles 416 (one shown) that vary according to a function across all or a portion of the rotor 216. The profile 416 in FIG. 4C varies according to a square or stepped function, but could alternatively vary according to a linear or polynomial function, without departing from the scope of the disclosure. The overall stiffness of the rotor 216 may further be altered by varying the geometry of the interface 422 between the rotor mandrel 314 and the rotor sleeve 420. The use of different materials that exhibit different physical characteristics in the rotor mandrel 314 and the rotor sleeve 420 may be taken into consideration in determining where to alter the geometry of the interface 422 along the length of the rotor 216. As illustrated, the thickness of the rotor sleeve 420 may be increased at the location 408h, but decreased along the length of location 408g. Depending on the materials used for the rotor mandrel 314 and its geometry, the rotor sleeve 420, and their respective physical characteristics, such changes in geometry may have the effect on either increasing or decreasing the stiffness of the rotor at those locations 408g,h.

As will be appreciated, any of the features described in the aforementioned embodiments of FIGS. 4A-4C to alter the geometry of the rotor 216 may be employed and otherwise used in any combination. For instance, one embodiment of the rotor 216 may exhibit a single feature, such as the profile 416 that varies according to a function. Another embodiment of the rotor 216 may have mass removed from one or both of the rotor mandrel 314 and the rotor sleeve 420. Another embodiment of the rotor 216 may include stiffening elements 412 arranged at select locations or along all or a portion of the outer periphery of the body 402 or the rotor bore 312. Those skilled in the art will readily appreciate the several variations that are feasible to selectively vary the stiffness of the rotor 216 and balance its resulting rotational weight with respect to the stiffness of the stator 214 (FIGS. 3A-3D), without departing from the scope of the disclosure.

In some embodiments, the geometry of the stator 214 and the stator housing 306 (FIG. 3A) may also be altered to selectively vary the stiffness of the motor 126. For instance, the outer surface of the stator housing 306 may be selectively profiled or externally undercut to vary the stiffness of the stator housing 306 relative to the stiffness of the rotor 216. As a result, the overall robustness of the motor 126 may be altered and otherwise optimized by modifying the stiffness of the rotor 216 in conjunction with portions of the stator 214, such as the stator housing 306.

Referring again to FIG. 1, with continued reference to FIGS. 2 and 4A-4C, in determining how to optimize the rotor stiffness and dynamic weight balance of the rotor 216, a planar approach may be adopted, where the change in wellbore azimuth 122 over the effective length of the motor is considered to be negligible. Wellbore interaction with the motor caused by irregular hole gauge (possibly the result of hole wash-out, sloughing, caving or cuttings build-up), may further exacerbate the mechanical loading of the motor 126.

The mechanical properties of the rotor 126 may also be taken into consideration in relation to the principal stresses that are active upon the power unit 202 and the overall motor 126. Having gained an understanding of the planar loading, the bending stress, torsional stress and axial stress components, the effects of downhole conditions and applied operating parameters may also be considered. Such operating parameters include, but are not limited to bending (e.g., weight on bit, stabilization, hole wash-out or sloughing, hole caving or cuttings build-up etc.), applied string RPM, string torque, and any combination thereof.

By considering the stress in both the rotor 216 and the stator 214, an assessment can be made regarding their relative stiffness in relation to the loading of the elastomer stator sleeve 308 (FIG. 3A), the stator coating 310 (FIG. 3B), and/or the rotor coating (FIG. 3D) in both conventional and uniform elastomer thickness power units (i.e., plain outer stator housing diameter or variable outer stator housing diameter [flexed]). The stress analysis may be based on standard mechanical stress calculations and/or on specifically developed drilling industry related calculations.

The maximum shear stress due to bending stress, torsional shear, and axial stress can generally be determined using standard calculations as follows:

$$\frac{1}{2} \sqrt{{( Bending Stress + Axial Stress )}^{2} + ( 4 \times Torsional {Shear}^{2} )} \qquad Equation ( 1 )$$

The maximum principal stress due to bending stress, torsional shear, and axial stress may be determined as follows:

$$\frac{1}{2} ( Bending Stress + Axial Stress ) + \frac{1}{2} \sqrt{{( Bending Stress + Axial Stress )}^{2} + ( 4 \times Torsional {Shear}^{2} )} \qquad Equation ( 2 )$$

Additionally, the Von Mises stress may be considered with respect to component yield stress:

$$\sqrt{{( Bending Stress + Axial Stress )}^{2} + 3 \times Torsional {Shear}^{2} )} \qquad Equation ( 3 )$$

The stresses in the rotor 216 and in the stator 214 are paired with respect to desired relative rotor and stator stiffness ratio criteria at discrete locations along their mated or paired longitudinal length, and along/over their full/entire/overall mated or paired longitudinal length, to achieve optimum mechanical loading of the rotor and stator lobe forms, of any stator lining, of any rotor or stator lobe form coatings, and of associated BHA drilling tools. Accordingly, the rotor 216 and the stator 214 may be physically modified at discrete locations along their mated or paired longitudinal length or otherwise along their full/entire/overall mated or paired longitudinal length to achieve a desired relative stiffness and mass balancing.

As the rotor 216 rotates within the stator 214, centrifugal load is created due to the mass of the rotor 216, which is resisted by the elastomer lining (e.g., the stator sleeve 308 and/or the stator coating 310) of the stator 214 along the length of the rotor 216. As mentioned above, the elastomer lining performs a radial bearing function with respect to the rotating mass of the rotor 216. The transmission shaft 222 (FIG. 2) is connected to the lower end of the rotor 216 and the upper end of the driveshaft 226 (FIG. 2). The transmission shaft 222 rotates due to the action of the rotor 216 and an additional centrifugal load is created due to the mass of the transmission shaft 222 and connections 218, 220. A portion of this load is transferred to the rotor 216 and is resisted by the internal stator lobe form (e.g. elastomer lining) of the stator 214.

The movement of the rotor 216 and the transmission shaft 222 (FIG. 2) causes vibration and shock loading, which can be detrimental to power production, can cause wear of the rotor 216 and the stator 214 and associated components. Torsional, lateral and longitudinal axis vibration originating at the rotor 216 and the stator 214 can affect the physical interaction between the rotor 216 and the stator 214 (i.e. increased compressive loading and rotor sliding and slippage), promoting fluid leakage at the seal generated between the rotor 216 and the stator 214, thereby reducing output torque and rotation.

Vibration loading originating from the drill bit 124 (FIGS. 1, 2 and 2A) and formation interactions tends to cause elastomer/coating wear and degradation, which promotes elastomer or coating overheating, hardening, and cracking. Vibration and shock loading imparted into the stator elastomer by the rotor 216 tends to cause hysteresis within the elastomer. During the hysteresis process, mechanical energy imparted into the elastomer manifests itself as internally generated heat within the elastomer, which is not completely dissipated. Over time, heat accumulates within the elastomer to an extent where the physical characteristics of the elastomer are detrimentally affected. Such vibration and shock loading can also cause interference in terms of electronic or pressure-based data transmission through/across motors and to/from measurement-while-drilling (MWD) and/or logging-while-drilling (LWD) tools within the BHA.

Only a portion of the load caused by the rotating mass of the transmission shaft 222 is resisted by the bearings in the bearing section 206 (FIG. 2). The elastomer lining of the stator 214, therefore, performs a radial bearing function with respect to the action of the rotating mass of the rotor 216 plus a portion of the load caused by the rotating mass of the transmission shaft 222 and the connections 218, 220.

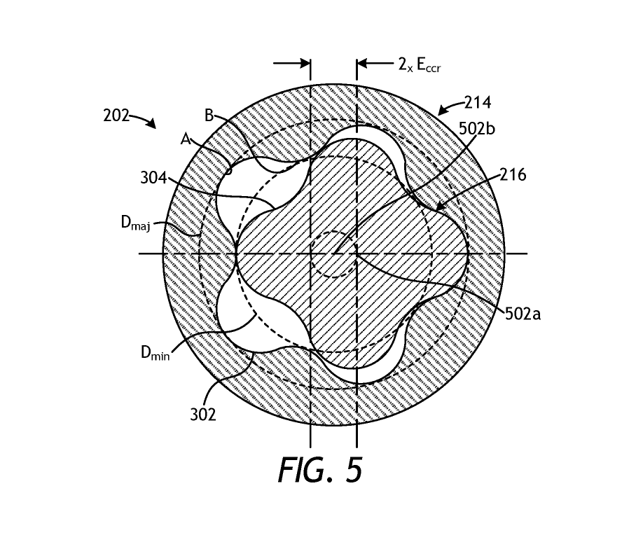

FIG. 5 is a cross-sectional end view of an example embodiment of a multi-lobe power unit 202 that schematically depicts the geometric interaction between the rotor 216 and the stator 214. Eccentricity (Eccr) can be related to the radial movement of the central axis 502a of the rotor 216 relative to the central axis 502b of the stator 214 as the central axis 502a of the rotor 216 moves during precession or nutation.

In FIG. 5, the geometric interaction between the rotor 216 and the stator 214 includes a major diameter Dₘₐⱼ and a minor diameter Dₘᵢₙ. The major diameter Dₘₐⱼ is defined by the diameter of a circle that radially circumscribes the outermost points of the stator lobes 302, at the lobe troughs A. The minor diameter Dₘᵢₙ is defined by the diameter of a circle that circumscribes the radially innermost points of the stator lobes, at the lobe crests B. The eccentricity of a mated rotor 216 and stator 214 pair is a function of the major diameter Dₘₐⱼ and the minor diameter Dₘᵢₙ. More particularly, the eccentricity of a mated rotor 216 and stator 214 pair, where the stator 214 has more than one lobe 302, equals:

$$\frac{( {D}_{maj} - {D}_{min} )}{4} \qquad Equation ( 4 )$$

The centrifugal/inertia force (F_{c}) of the rotor 216 is equal to the mass (M) of the rotor 216 multiplied by the rotational speed squared (v²), multiplied by the eccentricity (Eccr), as shown as follows:

F_{c}=M×v²×Eccr Equation (5)

In determining how to optimize the rotor stiffness and dynamic mass balance of the rotor 216, vibration caused by the motor 126 may also be considered. There are various aspects to consider when considering vibration caused by a downhole drilling motor such as, but not limited to, the mass of the rotor 216, eccentric movement of the rotor 216 within the stator 214 (i.e., eccentric rotation produces an imbalance), eccentric rotation speed (i.e., nutation), the fit between the rotor 216 and the stator 214 (i.e., the mating fit clearance or compression fit, rotating/fit and whether there is sliding/rubbing tendency, angular and parallel misalignment, etc.), the effects of the transmission shaft 222 (FIG. 2) (i.e., its mass and potential sub frequencies from moving elements), the effects of the driveshaft 226 (FIG. 2) (i.e., its mass and potential sub frequencies from moving elements), the adjustable housing offset (i.e., resulting rotor 216 offset to driveshaft 226 and rotor 216 loading against stator 214 lining along length), drilling fluid flow paths/pressure pulsation (i.e., progressing fluid cavities), any external damping (i.e., motor 126 geometry, formation contact, annular fluid, associated BHA components), and any combination thereof.

When the power unit 202 functions, there are two rotations present: clockwise rotation of the rotor 216 about its central axis 502a (FIG. 5), and anti-clockwise precessing rotation of the rotor 216 within the stator 214. Only clockwise rotation is transmitted to the drill bit 124 (FIGS. 1 and 2), the transmission section 204 (FIG. 2) negates the precession effects of the rotor 216.

Motor vibration mainly results from the mass, amount of eccentricity, and eccentric rotation speed of the rotor 216 within the stator 214. As the rotor 216 rotates inside the stator 214, these factors determine the amount of vibration that the power unit 202 may generate. The greater the mass, the larger the eccentricity and the greater the eccentric rotation speed and, consequently, the higher the resulting vibration.

The lobe profiles 302, 304 (FIGS. 3A-3D) are the same on the rotor 216 and the stator 214, they are produced on different effective pitch circle diameters, the rotor 216 having one less lobe 304 than the stator 214. The lobe 302, 304 form is designed to maximize rolling, minimize sliding and minimize mechanical loading (amplitude) as the rotor lobes 304 mesh at speed with the stator lobes 302. As the number of lobes 302, 304 increase, the depth and eccentricity of the lobe 302, 304 decrease, the frequency increases and the amplitude of loading tends to reduce.

The greatest centrifugal forces are generated at the eccentric rotation speed since the largest percentage of mass in the motor 126 is the rotor 216 and the eccentric rotation of the rotor 216 has the largest radius of gyration with respect to the offset rotating transmission shaft 222 (FIG. 2) and the concentric rotating driveshaft 226 (FIG. 2). The eccentric rotation speed of the rotor 216 is equal to the output RPM of the driveshaft 226 multiplied by the number of rotor lobes 304. The frequency (Hz) of the eccentric rotor 216 loading of the stator 214 equals the output RPM divided by 60 and multiplied by the number of rotor lobes 304. This defines the number of times a stator lobe 302 is loaded in a given unit of time.

As the number of lobes 302, 304 (FIGS. 3A-3D) increases, the loading frequency increases. Eccentric rotation speed of the rotor 216 tends to coincide with the strongest vibrations. Lesser vibration peaks tend to occur at integer orders of magnitude/multiples of eccentric rotation speed of the rotor 216, related to the number of rotor lobes 304. The resulting frequencies are relatively low (i.e., less than 500 Hz). The more significant vibration peaks (amplitudes) typically tend to occur at less than 100 Hz, when free running or loaded when on-bottom drilling.

Smaller diameter motors of less than 4¾ inch outer diameter with low lobe numbers tend to have relatively high output speeds. The eccentricity and mass of the smaller rotors is less, operating frequencies tend to be relatively high, and amplitudes are relatively low.

Vibration caused by drill bit 124 interactions with the formation generally has different amplitude-frequency signatures to the vibration generated by the motor 126. Torsional, lateral, and longitudinal axis vibration originating at the drill bit 124 can affect the physical interaction between the rotor 216 and the stator 214 (i.e. increased compressive loading and rotor sliding and slippage), promoting fluid leakage at the seal generated between the rotor 216 and the stator 214, thereby reducing output torque and rotation. The vibration loading from the drill bit 124 tends to cause elastomer/coating wear and degradation, which promotes elastomer or coating overheating, hardening and cracking.

The centrifugal loading produced by the rotor 216 is set with respect to desired loading criteria to achieve optimum dynamic loading of the rotor and stator lobe forms, of any stator lining, of any rotor or stator lobe form coatings, and of associated BHA drilling tools.

The speed and torque of the drill string 120 (FIG. 1) delivered to the motor 126 during drilling may also have a direct effect on how the power unit 202 actually functions in terms of its input-output operating envelope, its mechanical loading and efficiency. As will be appreciated, this affects the internally generated vibration signature of the motor 126.

Drilling fluid characteristics also affect the vibration signature of the motor 126 and interact with the rotor 216 and the stator 214 during operation. Hydraulic loading of the elastomer lining (e.g., the stator sleeve 308 and/or the stator coating 310) of the stator 214 is inherent to the progressing cavity power unit 202. The rotor 216 is effectively radially sealed and physically supported within the stator 214. Pressurized drilling fluid (or another circulating fluid) impinges on the upper end of the rotor 216/stator 214 combination. This results in hydraulic downthrust of the rotor 216. As the pressurized fluid passes (progresses) between the rotor 216 and the stator 214, the rotor 216 is forced to rotate, and allowable eccentric movement of the rotor 216 results in the rotor 216 precessing within the stator 214. During operation, the pressure inside the stator 214 may not be linear. Under some circumstances, for instance, the internal pressure builds towards the lower or downhole end of the stator 214. This is in addition to the loading effect of the rotating transmission shaft 222 (FIG. 2). According to the present disclosure, the geometry, stiffness, and/or mass of the rotor 216 may be varied to compensate for the hydraulic downthrust and internal pressure, which, to some extent, can negate or otherwise mitigate centrifugal loading and internal pressure.

As discussed above, the rotor 216 is connected to a transmission shaft 222 (FIG. 2), which is connected to a driveshaft 226 (FIG. 2). Thrust bearings within the bearing section 206 (FIG. 2) resist the downthrust load on the rotor 216 and downward movement. Mechanical loads are generated at the drill bit 124 as it engages the underlying formation interface and such loads are transmitted from the drill bit 124 to the lower end of the stator 214 via the driveshaft 226 and the transmission shaft 222. The rotating mass of the upper end of the transmission shaft 222 is essentially constrained by the lobe form 302 (FIGS. 3A-3D) of the stator 214 and, therefore, by any elastomer lining (e.g., the stator sleeve 308 and/or the stator coating 310) of the stator 214. The lower end of the stator 214 sustains higher mechanical loading from the effect of the transmission shaft 222 as compared to its top end. According to the present disclosure, the mass of the rotor 216 may be varied at discrete locations along its longitudinal length, and over its full/entire/overall longitudinal length. As will be appreciated, this may help compensate for the downthrust loads, and internal pressure, and the loads received from the drill bit 124, and thereby optimize the loading at the stator bore (lining or coating) and between the rotor 216 and stator 214 lobes at their interface, meshing, mating (seal) area.

The relative stiffness of the rotor 216 and the stator 214 and the mass of the rotor 216 are considered in relation to optimizing the functioning and reliability of the motor power unit 202, and the functioning of the full motor assembly, to benefit the functioning of associated BHA equipment, and to enhance directional drilling modelling, planning, and control.

Predictive mechanical analysis software is used to consider the behavior of the drill string 120 (FIG. 1) and BHA within the three-dimensional wellbore. The drill string 120 and BHA components are considered as an overall system, as individual drilling tools, and as sub-divided three-dimensional elements.

Many aspects are considered based on BHA component and physical characteristics. These are modelled in terms of various parameters being coincident upon the BHA, including wellbore curvature and inclination, side forces at component or element wellbore contact points, bending, torsional, longitudinal and combined stresses, in relation to directional trajectory tendency (azimuth and inclination), directional targets, critical rotational speeds, critical buckling loads and torque and drag (relative to localized wellbore tortuosity and doglegs). Manipulation or tuning of the stiffness, and mass balance of the power unit 202 of the motor 126 allows for the modelling and accurate physical configuration of the motor assembly in terms of planning for optimum motor performance, enhancing the reliability of associated BHA components and enhancing BHA directional trajectory control.

While the foregoing disclosure and description is related to downhole drilling motors, such as positive displacement motors or “mud motors,” those skilled in the art will readily appreciate that the principles discussed herein are equally applicable to other types of motors and pumps including, but not limited to, progressing cavity pumps used at a surface location or downhole. With surface-mounted or downhole progressing cavity pumps, for instance, the principles of the present disclosure may be applied to mass balance the various associated components of the pump(s), without departing from the scope of the disclosure.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. For example, a separate mechanism such as a dual mass flywheel or centrifugal pendulum absorber may be employed within a motor to improve rotor mass balance and reduce torsional fluctuations and vibration.

Embodiments disclosed herein include:

A. A method of manufacturing a power unit for a downhole drilling motor that includes fabricating a stator that provides two or more stator lobes that define an internal profile, fabricating a rotor that provides at least one rotor lobe that defines an external profile that precesses within the internal profile during operation, varying at least one of an external geometry and an internal geometry of the rotor along all or a portion of the rotor to alter a stiffness of the rotor and thereby optimize stiffness with respect to the stator, and rotatably positioning the rotor within the stator.

B. A power unit for a downhole drilling motor that includes a stator that provides two or more stator lobes that define an internal profile, and a rotor rotatably positioned within the stator and providing at least one rotor lobe that defines an external profile that precesses within the internal profile during operation, wherein at least one of an external geometry and an internal geometry of the rotor is varied along all or a portion of the rotor to alter a mass of the rotor and thereby optimize force balancing with respect to the stator.

Each of embodiments A and B may have one or more of the following additional elements in any combination: Element 1: wherein varying the external geometry of the rotor comprises altering a dimension of the external profile. Element 2: wherein varying the external geometry of the rotor comprises securing one or more stiffening elements to the external profile. Element 3: wherein the rotor defines a rotor bore and varying the internal geometry of the rotor comprises defining one or more internal recesses in the rotor bore. Element 4: wherein the rotor defines a rotor bore and varying the internal geometry of the rotor bore comprises defining one or more profiles in the rotor bore that extend axially along all or a portion of the rotor bore according to a function. Element 5: wherein the function is selected from the group consisting of a linear function, a polynomial function, a square function, and any combination thereof. Element 6: wherein the rotor defines a rotor bore and varying the internal geometry of the rotor comprises positioning one or more stiffening elements within the rotor bore. Element 7: further comprising selectively positioning the one or more stiffening elements within the rotor bore to optimize the stiffness with respect to the stator. Element 8: further comprising profiling an outer surface of the stator to selectively vary a stiffness of the stator. Element 9: wherein the rotor includes at least one of a rotor mandrel and a rotor sleeve, and wherein varying at least one of the external geometry and the internal geometry of the rotor comprises varying a stiffness of at least one of the rotor, the rotor mandrel, and the rotor sleeve relative to a stiffness of a stator housing and a stator lining. Element 10: wherein the rotor comprises a rotor sleeve that defines the external profile and a rotor mandrel positioned within the rotor sleeve and defining a rotor bore, the method further comprising varying a geometry of an interface between the rotor mandrel and the rotor sleeve to alter the stiffness of the rotor and thereby optimize a force balancing with respect to the stator. Element 11: wherein the rotor comprises a rotor sleeve that defines the external profile and a rotor mandrel positioned within the rotor sleeve and defining a rotor bore, the method further comprising mass balancing at least one of the rotor, the rotor sleeve, and the rotor mandrel.

Element 12: wherein the external geometry of the rotor is varied by altering a dimension of the external profile. Element 13: wherein one or more stiffening elements are secured to the external profile to vary the external geometry of the rotor. Element 14: wherein the rotor defines a rotor bore and one or more internal recesses are defined in the rotor bore to vary the internal geometry of the rotor. Element 15: wherein the rotor defines a rotor bore and one or more profiles are defined in the rotor bore and extend axially along all or a portion of the rotor bore according to a function to vary the internal geometry of the rotor. Element 16: wherein the function is selected from the group consisting of a linear function, a polynomial function, a square function, and any combination thereof. Element 17: wherein the rotor defines a rotor bore and one or more stiffening elements are positioned within the rotor bore to vary the internal geometry of the rotor. Element 18: wherein the one or more stiffening elements comprise weighting elements that optimize the force balancing with respect to the stator. Element 19: wherein the rotor comprises a rotor sleeve that defines the external profile and a rotor mandrel is positioned within the rotor sleeve. Element 20: wherein a geometry of an interface between the rotor mandrel is varied to alter a stiffness of the rotor with respect to a stiffness of the stator. Element 21: wherein an outer surface of the stator is profiled to selectively vary a mass of the stator. Element 22: wherein the stator comprises a stator housing and a stator sleeve positioned within the stator housing and defining the internal profile, and wherein the stator sleeve comprises a material selected from the group consisting of a metal, a metal alloy, a polymer and any combination thereof. Element 23: wherein the stator comprises a stator housing that defines the internal profile and a stator coating applied to the internal profile and comprising an elastomer or a rubber.

By way of non-limiting example, exemplary combinations applicable to A and B include: Element 6 with Element 7; Element 15 with Element 16; Element 17 with Element 18; and Element 19 with Element 20.

The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A method of manufacturing a power unit for a downhole drilling motor, comprising:
fabricating a stator that provides two or more stator lobes that define an internal profile;
fabricating a rotor that provides at least one rotor lobe that defines an external profile that precesses within the internal profile during operation;
varying at least one of an external geometry and an internal geometry of the rotor along all or a portion of the rotor to alter a stiffness of the rotor and thereby optimize stiffness with respect to the stator; and
rotatably positioning the rotor within the stator.

2. The method of claim 1, wherein varying the external geometry of the rotor comprises altering a dimension of the external profile.

3. The method of claim 1, wherein varying the external geometry of the rotor comprises securing one or more stiffening elements to the external profile.

4. The method of claim 1, wherein the rotor defines a rotor bore and varying the internal geometry of the rotor comprises defining one or more internal recesses in the rotor bore.

5. The method of claim 1, wherein the rotor defines a rotor bore and varying the internal geometry of the rotor bore comprises defining one or more profiles in the rotor bore that extend axially along all or a portion of the rotor bore according to a function.

6. (canceled)

7. The method of claim 1, wherein the rotor defines a rotor bore and varying the internal geometry of the rotor comprises positioning one or more stiffening elements within the rotor bore.

8. The method of claim 7, further comprising selectively positioning the one or more stiffening elements within the rotor bore to optimize the stiffness with respect to the stator.

9. (canceled)

10. The method of claim 1, wherein the rotor includes at least one of a rotor mandrel and a rotor sleeve, and wherein varying at least one of the external geometry and the internal geometry of the rotor comprises:
varying a stiffness of at least one of the rotor, the rotor mandrel, and the rotor sleeve relative to a stiffness of a stator housing and a stator lining.

11. The method of claim 1, wherein the rotor comprises a rotor sleeve that defines the external profile and a rotor mandrel positioned within the rotor sleeve and defining a rotor bore, the method further comprising varying a geometry of an interface between the rotor mandrel and the rotor sleeve to alter the stiffness of the rotor and thereby optimize a force balancing with respect to the stator.

12. The method of claim 1, wherein the rotor comprises a rotor sleeve that defines the external profile and a rotor mandrel positioned within the rotor sleeve and defining a rotor bore, the method further comprising mass balancing at least one of the rotor, the rotor sleeve, and the rotor mandrel.

13. A power unit for a downhole drilling motor, comprising:
a stator that provides two or more stator lobes that define an internal profile; and
a rotor rotatably positioned within the stator and providing at least one rotor lobe that defines an external profile that precesses within the internal profile during operation,
wherein at least one of an external geometry and an internal geometry of the rotor is varied along all or a portion of the rotor to alter a mass of the rotor and thereby optimize force balancing with respect to the stator.

14. The power unit of claim 13, wherein the external geometry of the rotor is varied by altering a dimension of the external profile.

15. The power unit of claim 13, wherein one or more stiffening elements are secured to the external profile to vary the external geometry of the rotor.

16. The power unit of claim 13, wherein the rotor defines a rotor bore and one or more internal recesses are defined in the rotor bore to vary the internal geometry of the rotor.

17. The power unit of claim 13, wherein the rotor defines a rotor bore and one or more profiles are defined in the rotor bore and extend axially along all or a portion of the rotor bore according to a function to vary the internal geometry of the rotor.

18. (canceled)

19. The power unit of claim 13, wherein the rotor defines a rotor bore and one or more stiffening elements are positioned within the rotor bore to vary the internal geometry of the rotor.

20. The power unit of claim 19, wherein the one or more stiffening elements comprise weighting elements that optimize the force balancing with respect to the stator.

21. The power unit of claim 13, wherein the rotor comprises a rotor sleeve that defines the external profile and a rotor mandrel is positioned within the rotor sleeve.

22. The power unit of claim 21, wherein a geometry of an interface between the rotor mandrel is varied to alter a stiffness of the rotor with respect to a stiffness of the stator.

23. (canceled)

24. (canceled)

25. The power unit of claim 13, wherein the stator comprises a stator housing that defines the internal profile and a stator coating applied to the internal profile and comprising an elastomer or a rubber.
